(19) United States
(12) Patent Application Publication
(10) Pub. No.: US 2014/0029665 A1
(43) Pub. Date: Jan. 30, 2014

(54) VIDEO ENCODING AND DECODING

(71) Applicant: Chris Damkat, Eindhoven (NL)

(72) Inventor: Chris Damkat, Eindhoven (NL)

(73) Assignee: KONINKLIJKE PHILIPS N.V., Eindhoven (NL)

(21) Appl. No.: 14/009,630

(22) PCT Filed: Mar. 30, 2012
(86) PCT No.: PCT/IB2012/051538

§ 371 Date: Oct. 3, 2013

(30) Foreign Application Priority Data
Apr. 8, 2011 (EP) 11161702.3

(51) Int. Cl. H04N 7/26

(52) U.S. Cl. CPC H04N 19/00139
USPC 375/240.03

(57) ABSTRACT

An encoder comprises a receiver (101) for receiving a video signal comprising at least one image. An estimator (107) determines a veiling luminance estimate for at least part of a first image of the at least one image in response to image content of one or more of the images. The veiling luminance estimate reflects an amount of eye glare generated in the eye by the image when rendered. A quantization adapter (109) determines a quantization scheme for the at least part of the first image in response to the veiling luminance estimate and an encoding unit (103, 105) encodes the video signal using the quantization scheme for the at least part of the first image. The veiling luminance estimate may be low-pass filtered to emulate human luminance adaptation. A corresponding decoder is provided. Improved encoding can be achieved, especially for High Dynamic Range images.

### FIELD OF THE INVENTION

The invention relates to video encoding and/or decoding and in particular, but not exclusively, to encoding and decoding of High Dynamic Range images.

### BACKGROUND OF THE INVENTION

Digital encoding of various source signals has become increasingly important over the last decades as digital signal representation and communication increasingly has replaced analogue representation and communication. Continuous research and development is ongoing in how to improve the quality that can be obtained from encoded images and video sequences while at the same time keeping the data rate to acceptable levels.

An important factor for perceived image quality is the dynamic range that can be reproduced when an image is displayed. However, conventionally, the dynamic range of reproduced images has tended to be substantially reduced in relation to normal vision. Indeed, luminance levels encountered in the real world span a dynamic range as large as 14 orders of magnitude, varying from a moonless night to staring directly into the sun.

However, traditionally the dynamic range of displays, specifically television sets, has been limited compared to the real life environment. Typically, the dynamic range of displays has been confined to about 2-3 orders of magnitude. For example, most studio reference monitors have a peak luminance of 80-120 cd/m² and a contrast ratio of 1:250. For these displays, the luminance levels, contrast ratio, and color gamut have been standardized (e.g. NTSC, PAL, and more recently for digital TV: Rec.601 and Rec.709). It has traditionally been possible to store and transmit images in 8-bit gamma-encoded formats without introducing perceptually noticeable artefacts on traditional rendering devices.

Recently, however, displays are being introduced with a much higher peak luminance (e.g. 4000 cd/m2) and a deeper black level resulting in a substantially larger dynamic range (5-6 orders of magnitude). These displays are typically referred to as High Dynamic Range (HDR) displays with the conventional displays being referred to as Low Dynamic Range (LDR) displays. These HDR displays approach the contrast and luminance levels we see in daily life. It is expected that future displays will be able to provide even higher dynamic ranges and specifically higher peak luminances and contrast ratios.

On the other side of the video production chain, cameras using film or electronic sensors are often used. Analog film cameras have been used in the past and are still widely used. The dynamic range (latitude) of analog film is very good (5-6 orders of magnitude) and therefore produces content with a high dynamic range. Until recently, digital video cameras using electronic tended to have a substantially reduced dynamic range compared to analog film. However, increased dynamic range image sensors capable of recording dynamic ranges of more than 6 orders of magnitude have been developed, and it is expected that this will increase further in the future. Moreover, most special effects, computer graphics enhancement and other post-production work are already routinely conducted at higher bit depths and with higher dynamic ranges. Also, video content is increasingly generated artificially. For example, computer graphics are used to generate video content in e.g. video games but also increasingly as movies etc. Thus, video content is increasingly captured with high dynamic ranges.

When traditionally encoded 8-bit signals are used to represent such increased dynamic range images, visible quantization and clipping artifacts are often introduced. Moreover, traditional video formats offer insufficient headroom and accuracy to convey the rich information contained in new HDR imagery.

As a result, there is a growing need for new approaches that allow a consumer to fully benefit from the capabilities of state-of-the-art (and future) sensors and display systems. In general, there is always a desire to provide improved encoding and/or decoding and in particular to achieve an improved perceived quality to data rate ratio.

Hence, an improved approach for encoding and/or decoding images, and in particular increased dynamic range images, would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an encoder for encoding a video signal, the encoder comprising: a receiver for receiving a video signal comprising at least one image; an estimator for determining a veiling luminance estimate for at least part of a first image of the at least one image in response to an image luminance measure of at least one of the at least one images; a quantization adapter for determining a quantization scheme for the at least part of the first image in response to the veiling luminance estimate; and an encoding unit for encoding the video signal using the quantization scheme for the at least part of the first image.

The invention may provide an improved encoding and may in particular provide an improved trade-off between data rate and perceived quality. In particular, it may allow the encoding to use quantization which more closely aligns with the perceived impact of the quantization.

The invention may in particular provide improved encoding of increased dynamic range images, such as HDR images. The approach may allow improved adaptation of the quantization to the visual impact, and may in particular allow adaptation of the quantization to focus on more visible brightness intervals.

The inventor has realized that in contrast to conventional coding schemes, substantially improved performance can in many scenarios be achieved by considering the perceptual effect of eye glare and veiling luminance in determining a quantization scheme for the encoding. The inventor has realized that, in particular for new HDR content, the impact of eye glare and veiling luminance can become perceptually significant and lead to significant improvement when considered in the adaptation of the quantization.

Eye glare occurs due to scattering of light in the eye which causes e.g. bright light sources to result in a veiling glare that masks relatively darker areas in the visual field. Conventionally, such effects have been dominated by the impact of viewing ambient light sources (e.g. watching in bright sun light) and have not been considered when encoding a signal. However, the inventor has realised that in particular for new displays, the effect of eye glare caused by the display itself can advantageously be considered when quantising the signal. Thus, the approach may consider the effect of eye glare caused by the display of the image itself when encoding the image.

The inventor has furthermore realised that such an approach can be achieved without unacceptably increasing complexity and resource requirements. Indeed, it has been found that adapting the quantization in response to even low complexity models for estimating the veiling luminance can provide substantially improved encoding efficiency.

The part of the first image for which the veiling luminance is determined may be a pixel, a group of pixels, an image area or the first image as a whole. Similarly, the image luminance measure may be determined for a group of pixels, an image area or the whole of one or more images. The image luminance measure may typically be determined from the first image itself.

The quantization scheme may specifically be a luminance quantization scheme. The quantization scheme may specifically correspond to a quantization function translating a continuous (luminance) range into discrete values.

In some embodiments, the video signal may comprise only one image, i.e. the at least one image may be a single image. In some embodiments, the video signal may be an image signal (with a single image).

The determination of the veiling luminance estimate and/or the quantisation scheme may be based on a nominal or standard display. For example, a nominal (e.g. HDR) display having a nominal luminance output (e.g. represented by a black level, a peak level or a nominal luminance level) may be considered and used as the basis for determining e.g. the veiling luminance estimate. In some embodiments, the determination of the veiling luminance estimate may be based on characteristics of a specific display to be used for rendering, such as e.g. maximum brightness, size, etc. In some embodiments, the estimator may be arranged to determine a veiling luminance estimate based on a nominal display and then adapt the veiling luminance estimate in response to characteristics of a display for rendering of the image.

In accordance with an optional feature of the invention, the quantization scheme corresponds to a uniform perceptual luma quantization scheme for the veiling luminance estimate.

This may provide a particularly efficient encoding and may in particular allow the quantization to be closely adapted to the perception of a viewer when viewing the image.

The uniform perceptual luma quantization may be a quantization in the perceptual luma domain which represents a quantization wherein each quantization step results in the same perceived increase in lightness (as measured by the specific model used for the human vision system in the specific embodiment). Thus, the uniform perceptual luma quantization represents perceptually uniform steps in the perceived luminance. The uniform perceptual luma quantization may thus correspond to an equidistant sampling of the luma values in a perceptual luma domain.

The uniform perceptual luma quantization scheme may comprise quantization steps which have equal perceptual significance for a given human perception model. Specifically, each quantization interval of the uniform perceptual luma quantization scheme may correspond to the same (possibly fractional) number of Just Noticeable Differences (JNDs). Thus, the uniform perceptual luma quantization scheme may be generated as a number of quantization intervals wherein each quantization interval has a size of a JND multiplied by a given scaling factor (possibly with a value less than one), where the scaling factor is the same for all quantization intervals.

In accordance with an optional feature of the invention, the quantization adapter is arranged to: determine a uniform quantization scheme in a perceptual luma domain; determine a mapping function relating perceptual luma values to display values in response to the veiling luminance estimate; and determine a non-uniform quantization scheme for display values in response to the uniform quantization scheme in the perceptual luma domain and the mapping function.

This may provide for a particularly efficient adaptation of quantization. An advantageous trade-off between data rate and perceived quality may be achieved while allowing an efficient implementation. The approach may allow resource requirements to be kept relatively low.

In particular, the approach may allow a low complexity approach for determining a quantization scheme for display values such that each quantization step has a substantially equal perceptual significance.

The step of determining a uniform quantization scheme in the perceptual luma domain may be an implicit operation and may be performed simply by considering specific values of the mapping function. Similarly, the step of determining a mapping function may be implicit and may e.g. be achieved by using a predetermined mapping function for which the input values or output values are compensated in response to the veiling luminance estimate. The steps of determining the uniform quantization and the mapping function may be performed by the application of a suitable model.

The quantization scheme for display values may specifically be a non-uniform quantization scheme.

The display values may be any values representing the luminance to be output from a display. As such, they may relate to values received from a camera, values to be provided to a display, or any intermediate representation. The display values may represent any values representing an image to be displayed, and specifically may represent values anywhere in the path from image capture to image rendering.

The display values may be linear luminance values or may be non-linear luminance values. For example, the display values may be gamma compensated (or otherwise transformed) values. The gamma compensation (or other transform) may be included in the specific mapping function and/or may be included as a pre- and/or post processing.

The perceptual luma domain reflects the perceived lightness differences in accordance with a given human perception model. The uniform quantization scheme in the perceptual luma domain may be a uniform perceptual luma quantization scheme which comprises quantization steps that have equal perceptual significance in accordance with a human perception model. Specifically, each quantization interval of the uniform perceptual luma quantization scheme may correspond to the same (possibly fractional) number of JNDs. Thus, the uniform quantization scheme may be generated as a number of quantization intervals, wherein each quantization interval has a size of a JND multiplied by a given scaling factor, where the scaling factor is the same for all quantization intervals.

The display values typically correspond to the pixel values. The pixel values may e.g. be in the (linear) luminance domain, such as YUV or YCrCb values, or may e.g. be in a display drive luma domain (e.g. gamma compensated domain) such as Y′UV or Y′CrCb values (where ′ indicates a gamma compensation).

The non-uniform quantization scheme for display values may specifically be a non-uniform quantization scheme for display luminance values. For example, the non-uniform quantization scheme may be applied to the luminance component of a colour representation scheme, such as to the samples of the Y component of a YUV or YCrCb colour scheme. As another example, the non-uniform quantization scheme in the luminance domain may be employed as a quantization scheme in a display drive luma colour scheme, such as a gamma compensated scheme. E.g. the determined quantization scheme may be applied to the Y′ component of a Y′UV or Y′CbCr colour scheme. Thus, the non-uniform quantization scheme for display values may be a quantization scheme for display drive luma values.

The display values may specifically be display luminance values. For example, the display luminance values may be the samples of the luminance component of a colour representation scheme, such as to the samples of a Y component of a YUV or YCbCr colour scheme.

The display values may specifically be display drive luma values. For example, the display luma values may be derived from the display drive luma component of a colour representation scheme, such as to the samples from a Y′ component of a Y′UV or Y′CbCr colour scheme.

E.g. an RGB, YUV or YCbCr signal can be converted in to a Y′UV or Y′CbCr signal, and vice versa.

The mapping function may typically provide a one-to-one mapping between the perceptual luma values and the display (luminance) values, and may accordingly e.g. be provided as a function which calculates a perceptual luma value from a display luminance value, or equivalently as a function which calculates a display luminance value from a perceptual luma value (i.e. it may equivalently be the inverse function).

The approach may thus in particular use a model for the perceptual impact of eye glare which is represented by a possibly low complexity mapping function between perceptual luma values and display values, where the mapping function is dependent on the veiling luminance estimate.

The mapping function may represent an assumed nominal or standard display, e.g. the mapping function may represent the relationship between the perceptual luma domain and the display values when presented on a standard or nominal display. The nominal display may be considered to provide the correspondence between sample values and the resulting luminance output from the display. For example, the mapping function may represent the relation between the perceptual luma values and the display values when rendered by a standard HDR display with a dynamic range from e.g. 0.05-2000 cd/m². In some embodiments, the mapping function may be modified or determined in response to characteristics of a display for rendering. E.g. the deviation of a specific display relative to the nominal display may be represented by the mapping function.

In accordance with an optional feature of the invention, quantization intervals of the non-uniform quantization scheme for display values comprises fewer quantization levels than the uniform quantization scheme in the perceptual luma domain.

This may allow reduced data rate for a given perceptual quality. In particular, it may allow the number of bits used to represent the display to be reduced to only the number of bits that are required to provide a desired perception. For example, only the number of bits resulting in perceptually differentiable values need to be used.

In particular, for some veiling luminance estimates, some of the quantization intervals of the non-uniform perceptual luma quantization scheme may correspond to display luminances which are outside the range that can be presented by a display (or represented by the specific format).

In accordance with an optional feature of the invention, quantization interval transitions of the non-uniform quantization scheme for display values corresponds to quantization interval transitions of the uniform quantization scheme in the perceptual luma domain in accordance with the mapping function.

This provides a particularly advantageous operation, implementation and/or performance.

In accordance with an optional feature of the invention, the estimator is arranged to generate the veiling luminance estimate in response to an average luminance for at least an image area of the first image.

This provides a particularly advantageous operation, implementation and/or performance. In particular, it has been found that improved performance can be achieved even for very low complexity models for the veiling luminance estimate.

The image area may be part of the first image or may be the whole of the first image. The image area may be the same as the part of the first image for which the veiling luminance estimate is determined.

In accordance with an optional feature of the invention, the estimator is arranged to determine the veiling luminance estimate substantially as a scaling of the average luminance.

This provides a particularly advantageous operation, implementation and/or performance. In particular, it has been found that improved performance can be achieved even for very low complexity models for the veiling luminance estimate.

The veiling luminance estimate may in many embodiments advantageously be determined as between 5% and 25% of the average luminance.

In accordance with an optional feature of the invention, the estimator is arranged to determine the veiling luminance estimate as a weighted average of luminances in parts of successive images. This provides a particularly advantageous operation, implementation and/or performance. In particular it may allow the quantization to take into account luminance adaptation of the eye while maintaining low complexity.

Luminance adaptation is the effect that whereas human vision is capable of covering a luminance range of around 14 orders of magnitude, it is only capable of a dynamic range of around 3-5 orders of magnitude at any given time. However, the eye is able to adapt this limited instantaneous dynamic range to the current light input. The inventor has realized that the effect of such eye luminance adaptation can be estimated by a suitable low pass filtering of the veiling luminance estimate. Thus, the approach allows for a combined modeling of both the luminance adaptation and the eye glare effects.

The determination of a veiling luminance estimate as the weighted average of (at least) parts of successive images may temporally low pass filter the veiling luminance estimate for a given image area (including possibly the whole image) in a sequence of images.

In accordance with an optional feature of the invention, the weighted average corresponds to a filter with 3 dB cut-off frequency of no higher than 2 Hz.

This may provide particularly advantageous performance. In particular, a very slow adaptation may provide a more accurate emulation of the behavior of the luminance adaptation of the human eye. Indeed, in many embodiments, the 3 dB cut-off frequency for a low pass filter generating the weighted average may particularly advantageously be no higher than 1 Hz, 0.5 Hz or even 0.1 Hz.

In accordance with an optional feature of the invention, the weighted average is asymmetric having a faster adaptation for increments in the veiling luminance estimate than for decrements in the veiling luminance estimate.

This may provide particularly advantageous performance. In particular, an asymmetric adaptation may provide a more accurate emulation of the behavior of the luminance adaptation of the human eye.

Indeed, in many embodiments, the 3 dB cut-off frequency for the weighted average may for decrements in the veiling luminance estimate particularly advantageously be no higher than 2 Hz, 1 Hz, 0.5 Hz or even 0.1 Hz whereas the 3 dB cut-off frequency for the weighted average for increments in the veiling luminance estimate may particularly advantageously be no lower than 3 Hz, 10 Hz or even 20 Hz. In some embodiments, the filtered veiling luminance estimate may directly follow the instantaneous veiling luminance estimate for increments, and be low pass filtered for decrements. In many embodiments, the 3 dB cut-off frequency for the low pass filter for increments in the veiling luminance estimate may be no less than ten times the 3 dB cut-off frequency for the low pass filter for decrements in the veiling luminance estimate.

In accordance with an optional feature of the invention, the encoder unit is arranged to include an indication of the veiling luminance estimate in an encoded output signal.

This provides a particularly advantageous operation, implementation and/or performance.

In accordance with an optional feature of the invention, the quantization scheme is determined for a first image area, and the veiling luminance estimate is determined for a second image area.

This may provide improved performance in many scenarios, and may in particular allow improved adaptation of the quantization to the viewer's ability to differentiate details.

The first and second image areas may be different.

In accordance with an optional feature of the invention, the first image area is an image area having a higher than average luminance, and the second image area is an image area having a lower than average luminance.

This may provide improved performance in many scenarios, and may in particular allow improved adaptation of the quantization to the viewer's ability to differentiate details. The first image area may have a luminance higher than the average luminance of the image and may in particular have an average luminance no less than 50% higher than the average luminance of the image. The second image area may have a luminance lower than the average luminance of the image, and may in particular have an average luminance no more than 25% of the average luminance of the image.

According to an aspect of the invention there is provided a decoder for decoding an encoded video signal comprising at least one image, the decoder comprising: a receiver for receiving the encoded video signal, the encoded video signal comprising an indication of a veiling luminance estimate for at least part of a first image of the at least one images; a de-quantization adaptor for determining a de-quantization scheme for the at least part of a first image in response to the veiling luminance estimate; and a decoding unit for decoding the encoded video signal using the de-quantization scheme for the at least part of the first image.

According to an aspect of the invention there is provided a method of encoding a video signal; the method comprising: receiving a video signal comprising at least one image; determining a veiling luminance estimate for at least part of a first image of the at least one image in response to an image luminance measure for at least one of the at least one images; determining a quantization scheme for the at least part of the first image in response to the veiling luminance estimate; and encoding the video signal using the quantization scheme for the at least part of the first image.

According to an aspect of the invention there is provided a method of decoding an encoded video signal comprising at least one image; the method comprising: receiving the encoded video signal, the encoded video signal comprising an indication of a veiling luminance estimate for at least part of a first image of the at least one images; determining a de-quantization scheme for the at least part of the first image in response to the veiling luminance estimate; and decoding the encoded video signal using the de-quantization scheme for the at least part of the first image.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of elements of a video signal encoder in accordance with some embodiments of the invention;

FIG. 2 illustrates the effect of eye glare;

FIG. 3 illustrates an example of functions relating a perceptual luma and a display luminance;

FIG. 4 is an illustration of an example of light adaptation of the human eye;

FIG. 5 is an illustration of an example of elements of a video signal decoder in accordance with some embodiments of the invention; and

FIG. 6 is an illustration of an example of elements of a video signal encoder in accordance with some embodiments of the invention.

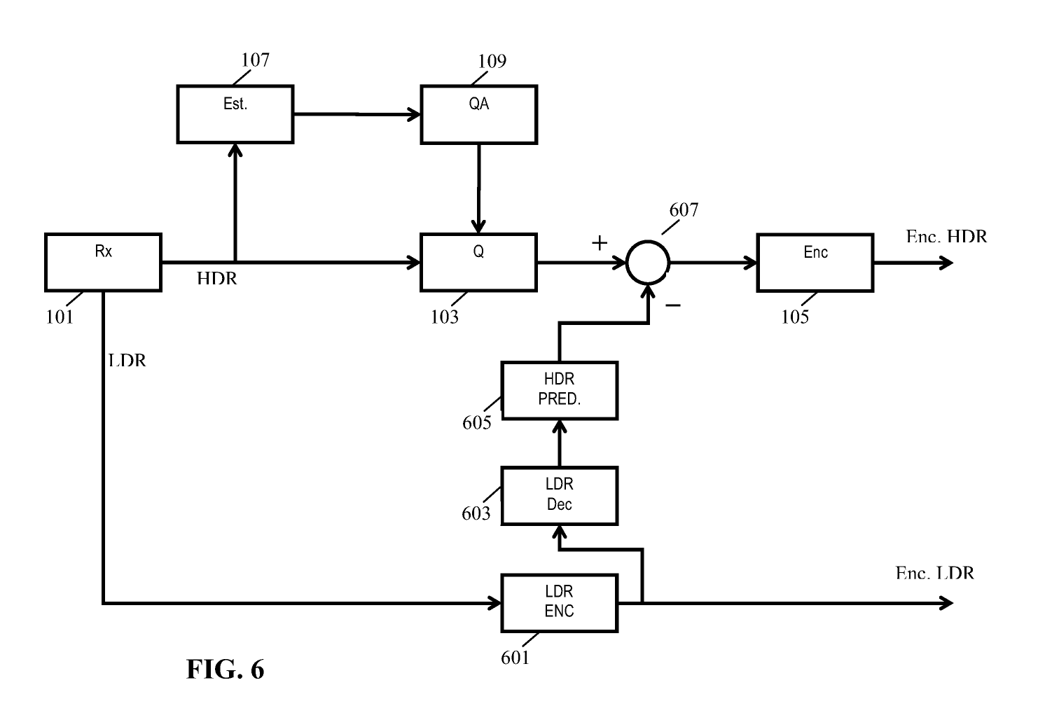

### DETAILED DESCRIPTION OF SOME EMBODIMENTS OF THE INVENTION

The following description focuses on embodiments of the invention applicable to an encoding and decoding system for a sequence of High Dynamic Range (HDR) images. However, it will be appreciated that the invention is not limited to this application but may be applied to many other types of images as well as to individual single images, such as digital photographs.

The following examples will focus on scenarios where the physical video signals and colour representations use a luminance representation that does not include display drive compensations, and specifically which do not include gamma compensations. For example, the pixels may use RGB, YUV or YCbCr colour representation schemes which are widely used in e.g. computer generated, distributed and rendered video content. However, it will be appreciated that the described principles can be applied to or converted to display drive compensated schemes, and in particular to display drive compensated schemes, and in particular to gamma compensated schemes such as R′G′B′, Y′UV or Y′CbCr which are widely used in video systems.

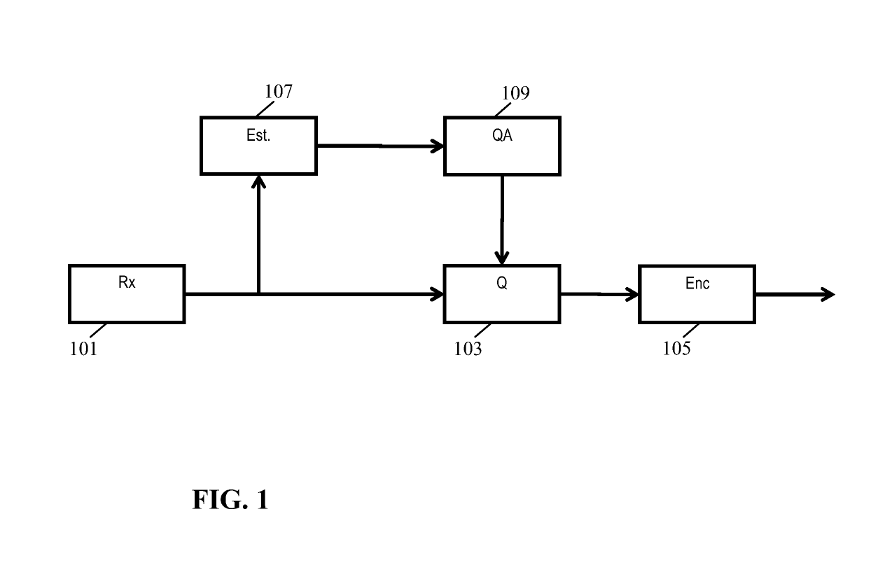

FIG. 1 illustrates an example of elements of a video signal encoder in accordance with some embodiments of the invention. The encoder comprises a receiver 101 which receives a video signal to be encoded. The video signal may for example be received from a camera, a computer graphics source, or from any other suitable external or internal source. In the example, the video signal is a digital video signal comprising non-compressed pixel sample data for a sequence of images. The video signal is specifically a colour signal with the sample data being provided in accordance with a suitable colour representation. In the specific example, the colour representation uses one luminance component and two chroma components. E.g. the samples may be provided in accordance with an YUV or YCrCb colour representation format. In the example, the luminance representation is a linear luminance representation (i.e a doubling in the value of the luminance corresponds to a doubling of the light output from the corresponding display).

In other examples, the samples may be provided in accordance with a display drive compensated colour scheme such as for example a R′G′B′, Y′UV or Y′CbCr. For example, the samples may be provided from a video camera in accordance with the standard Rec.709. In such examples, colorspace transformation may e.g. be applied to convert into a luminance representation (such as e.g. between Y′UV and RGB).

As an example, for a conventional video camera, the recorded video signal may be in a gamma compensated representation wherein the linear representation of captured light is converted to a non-linear representation using a suitable gamma compensation. In such examples, the input signal may thus be provided in a gamma compensated representation. Similarly, for conventional video displays, the drive signals may typically be provided in accordance with a non-linear gamma compensated representation (e.g. corresponding to the signal provided from a conventional camera). In some embodiments, the encoded data output may accordingly also be provided in accordance with a gamma compensated format. Alternatively, in some embodiments, the input signal may be provided in a linear representation format, e.g. if the input images are provided by a computer graphics source. In some embodiments, the encoded data may similarly be provided in a linear representation, e.g. if the encoded data is provided to a computer for further processing. It will be appreciated that the principles described in the following may equally be applied to signals in accordance with any suitable linear or non-linear representation, including for example embodiments wherein the input signal is gamma compensated and the output is not (or vice versa).

The video signal is forwarded to a perceptual quantizer 103 which performs a quantization of the image samples in accordance with a suitable quantization scheme. The quantized image samples are then fed to an encoder unit 105 which proceeds to perform a suitable encoding of the image samples.

It will be appreciated that although the encoding and quantising functionality is illustrated as sequential operations in the example of FIG. 1, the functionality may be implemented in any order and may typically be integrated. For example, the quantization may be applied to a part of the encoded signal. E.g. the encoding may include segmentation into macro-blocks which are encoded based on a DCT being applied thereto. The perceptual quantization may in some embodiments be applied in the corresponding frequency domain.

However, in the specific embodiment described in the following, the perceptual quantization is applied to luminance samples of the images of the video signal prior to the encoding by the encoding unit 105.

In the system of FIG. 1, the quantization is not a static quantization but is rather dynamically adapted based on an estimate of the veiling luminance or eye glare that is generated in the eye by the images being presented.

Specifically, the encoder of FIG. 1 comprises an estimator 107 which receives the input images from the receiver 101 and which determines a veiling luminance estimate for at least part of an image of video sequence. The veiling luminance estimate is determined based on an image luminance measure for at least part of one or more of the images of the video signal. Typically, the veiling luminance estimate is determined based on a luminance measure determined from the image itself. The veiling luminance estimate may also (or possibly alternatively) be determined based on luminance measures of previous images.

As an example, the luminance of the whole or part of the image may be calculated and the veiling luminance estimate may be determined by multiplication thereof with a suitable factor.

The encoder of FIG. 1 further comprises a quantization adaptor 109 which is coupled to the estimator 107 and which receives the veiling luminance estimate therefrom. The quantization adaptor 109 then proceeds to determine a quantization scheme to be used by the part of the image for which the veiling luminance estimate has been determined. The quantization scheme is determined on the basis of the veiling luminance estimate.

The quantization scheme may specifically correspond to a quantization function translating a continuous (luminance) range into discrete values.

Thus, the quantization scheme which is used for a given image area is dependent on a veiling luminance estimate generated for the image area. In many embodiments, a single veiling luminance estimate may be generated for the entire image and this veiling luminance estimate may be used for determining the quantization scheme for all image areas. Indeed, the quantization scheme may be the same for the entire image. However, in other embodiments, each veiling luminance estimate may apply to only a smaller image area, and for example a plurality of veiling luminance estimates may be determined for each image. Consequently, different quantization schemes may be used for different areas of the image thereby allowing the system to adapt the quantization scheme to local conditions and e.g. allowing a different quantization scheme to be used for low and high contrast areas of an image.

The adaptation of the quantization based on an estimate of how much eye glare is generated in the viewer's eye may provide a significantly improved data rate to perceived quality ratio. The system not only considers aspects of the display of the images and the resulting generated image, but also considers the perceptual implications and uses this to adapt the operation of the system.

The approach can thus use an estimate of the eye glare level to quantize visually redundant video data. This can in particular result in an increased quantization in relatively dark areas thereby allowing a reduced data rate.

It has further been found that the perceptual model used for determining the veiling luminance estimate does not have to be complex but rather significant performance improvement can be achieved even for very low complexity models. Indeed, in many embodiments, a global veiling luminance estimate for the image as a whole can be used. Thus, the quantization scheme can be selected globally for the image on an image by image (frame-by-frame) basis.

The coding overhead for additional data required to indicate the quantization scheme used can be very limited and easily outweighed by the reduction in data due to the improved quantization. E.g. a single value veiling luminance estimate may be communicated to the decoder for each image.

In particular for increased dynamic range images, such as HDR images, the eye glare may become increasingly significant, and the described approach can adapt for the eye glare that is introduced by the HDR image itself when presented to a viewer. Indeed, the effect of eye glare or veiling luminance that occurs due to scattering of light in the eye is much more important for high contrast stimuli. The bright light sources, including those in the image itself, can result in a veiling glare or luminance that masks relatively darker areas in the visual field. This effect limits the viewer's ability to see details in darker areas of a scene in the presence of a bright light source, such as the sun or a sky.

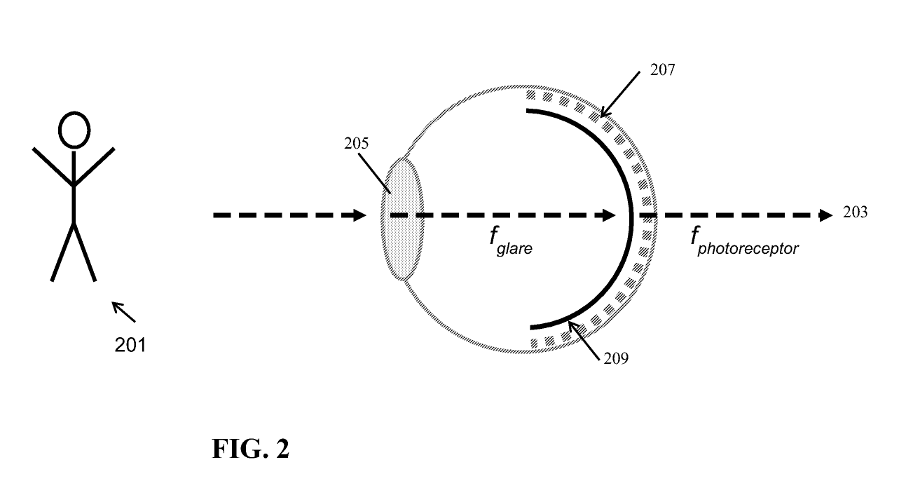

FIG. 2 illustrates an example of an eye model illustrating the perceptual concept of eye glare/veiling luminance. The figure illustrates the translation of light emitted from a real scene 201 into a perceived image 203. First the light passes through the lens 205 and eye body to form an image on the retina 207, the retinal image 209. While passing through the eye the light is scattered. This affects the formation of the retinal image 209, i.e. it adds a veiling glare/luminance. The retinal image is then translated into neural responses by the photoreceptors, which finally leads to perception. These photoreceptors have a limited dynamic range and in case of a temporal luminance change they need time to adapt. In this mapping process, a significant amount of image detail can be masked. The amount of masked detail depends on the dynamic range of the real scene and the current adaptation state relative to the current stimulus luminance.

The effect of eye glare or veiling luminance can be demonstrated by a consideration of the perception of luminance differences by the human visual system. Indeed, research into the human visual system has demonstrated that the visibility of a temporal or spatial change in luminance depends primarily on the luminance ratio, the contrast, rather than on the absolute luminance difference. Consequently, luminance perception is non-linear and in fact approximates a log function of the luminance. This non-linear perception can be modeled using complex models, but the masking effect caused by eye glare can be demonstrated by a consideration of a measure of the perceived contrast. For example, the Weber contrast may be used as a perceptual measure. The Weber contrast is given by:

$$C = \frac{Y - {Y}_{b}}{{Y}_{b}} ,$$

where Y denotes luminance or intensity of an object standing out from the background, and Y_{b} is the local background luminance.

The effect of glare has been examined in detail and a model is described in Vos, J. J., van de Berg, T. J. T. P., “Report on disability glare”, CIE Collection on Colour and Vision 135(1), 1999, p. 1-9. From this model a point spread function can be created to calculate the veiling glare locally. This veiling glare is modeled by a veiling luminance that is added to the local background luminance. This changes the local perceived contrast. In effect, the contrast of detail in dark areas is reduced significantly. This is how scattering affects the formation of the retinal image.

The contrast with scattering induced veiling luminance can be calculated as:

$${C}_{glare} = \frac{Y - {Y}_{b}}{{Y}_{b} + {Y}_{veil}}$$

where Yᵥₑᵢₗ is the veiling luminance caused by scattering in the eye, i.e. the glare. This equation indicates that there is always a contrast reduction, i.e. C_{glare}<C.

The amount of contrast reduction due to glare can be calculated by:

$$\frac{C}{{C}_{glare}} = \frac{\frac{Y - {Y}_{b}}{{Y}_{b}}}{\frac{Y - {Y}_{b}}{{Y}_{b} + {Y}_{veil}}} = \frac{{Y}_{b} + {Y}_{veil}}{{Y}_{b}}$$

Thus, as illustrated by this equation, the presence of veiling luminance reduces the perceived contrast and also affects the relative perceived luminance changes in a non-linear way. In the system of FIG. 1, these perceptual factors are considered when determining how to quantise the image data.

It will be appreciated that many different approaches or means for estimating the veiling luminance may be used. In general a veiling luminance model for the human eye may be used to generate the veiling luminance estimate based on the image content of the image itself and/or one or more previous images.

In some embodiments, the veiling luminance estimate may be generated in response to an average luminance for an image area. The image area in which the average luminance is determined may correspond to the image area for which the veiling luminance estimate is determined. For example, the image area may correspond to the entire image, and thus a single veiling luminance estimate for an image may be determined based on the average luminance of the image (and/or the average luminance of one or more previous images).

The veiling luminance estimate is in the system of FIG. 1 determined based on the image samples for the image. However, these values are indicative of relative luminances rather than the absolute physical luminance from a display. Indeed, the actual luminance corresponding to a given pixel sample depends on the specific display rendering the signal, and indeed the settings of the display (such as e.g. the current brightness settings). As such the actual rendered luminances are generally not known by the encoder and at the encoding stage, and therefore the encoding may typically be based on the characteristics of a nominal or standard display. Specifically, the image samples may be related to display output luminances assuming a given standard display with standard settings. For example, the correlation between image samples and luminance output may be assumed to be those resulting from a rendering of the image on a nominal HDR display having an output dynamic luminance range from 0.05-2000 cd/m².

In other embodiments, the characteristics of a specific display to be used for rendering of the image may be used. E.g. if it is known that an HDR display having an output dynamic luminance range from 0.05-4000 cd/m² is to be used, the system may be adapted accordingly.

In scenarios where the veiling luminance estimate is determined for a relative small area (such as e.g. when a plurality of veiling luminance estimates are determined for an image), the average luminance may be based on a larger area. For example, a veiling luminance estimate may possibly be determined for each individual macro-block based on the average luminance of e.g. an image area of 5 by 5 macro-blocks centred on the macro-block.

In some embodiments, advantageous performance may be achieved by determining the veiling luminance estimate in response to an average luminance of no more than 10% of an area of the first image. In some embodiments further advantageous performance may be achieved for even smaller areas, and in particular in some embodiments the average luminance may be determined for individual macro-blocks. The area does not need to be a single contiguous area. The average luminance may for example be determined based on a subsampling of the whole or parts of the image in accordance with a suitable pattern.

In some embodiments the veiling luminance estimate may be determined as a scaling of the average luminance. Indeed, in many scenarios the veiling luminance may simply be estimated as a fraction of the average luminance of the presented image. In many typical applications, the veiling luminance may be estimated to correspond to between 5% and 25% of the average luminance.

Indeed, it has been found that the effect of eye glare tends to be spatially low frequent and therefore the spatial variation can be ignored in many embodiments. In such embodiments, the effect of the veiling luminance in the perceptual quantization can be approximated as a global, constant effect. It has furthermore been found that a reliable and efficient approximation for the global veiling luminance is achieved by considering the veiling luminance to be proportional to the average luminance of the rendered image.

Thus, specifically the veiling luminance estimate may be given as:

Yᵥₑᵢₗ=α·Y_{average}

where α is a tuning parameter related to the amount of light scattered in the eye. A value in the order of 10% is particularly appropriate for many applications. Thus, the amount of scattered light is often in the order of 10%, although this can vary from person to person and tends to increase with age.

In many embodiments, the quantization adaptor 109 is arranged to determine a luminance quantization scheme for the luminance of the image samples which has a desired characteristic in the perceptual luma domain. In particular, the quantization adaptor 109 may determine the luminance quantization scheme such that it corresponds to a uniform perceptual luma quantization scheme. Thus, the luminance quantization scheme can be designed to have quantization steps that correspond to an equal perceived luminance change.

The uniform perceptual luma quantization scheme may specifically correspond to an example where each quantization step corresponds to a given amount of Just Noticeable Differences (JND). A JND is the amount of luminance change which can just be perceived. Thus, in a scenario wherein the perceptual luma quantization uses steps of one JND, each quantization step is just noticeable by a viewer. Furthermore, due to the characteristics of the human vision (as previously described), a uniform quantization step in the perceptual domain corresponds to different luminance steps in the real world dependent on the actual luminance (and veiling luminance), i.e. it corresponds to different luminance steps for the luminance of the display panel. In other words, a perceptual luma JND quantization step for a dark pixel/image area may correspond to a given display luminance interval (e.g. measured in cd/m²). However, for a bright pixel/image area, the perceptual luma JND quantization step may correspond to a substantially higher display luminance interval (e.g. measured in cd/m²).

Thus, in order to achieve a perceptually uniform luminance quantization, the display luminance quantization (and consequently the image data luminance quantization) must be non-uniform. Furthermore, the correspondence between uniform quantization steps in the perceptual luma domain and the non-uniform quantization steps in the display luminance domain depend on the eye glare and this is in the system of FIG. 1 taken into consideration by the determined quantization scheme depending on the veiling luminance estimate.

For the avoidance of doubt, it is noted that perceptual luma refers to the model's perceived lightness variations by the human vision system as determined by the model of the human vision used in the specific example. This is differentiated from the use of the term luma for display compensating operations as is sometimes applied in the field. For example, the gamma power law (or other similar non-linear display driving operations) that compensate for non-linearities in traditional Cathode Ray Tubes are sometimes referred to using the term “luma”. However, the use of the term in this description is intended to reflect the perceptual luma, i.e. the perceived lightness changes. Thus, the term perceptual luma refers to the psycho-visual differences rather than to display characteristic compensation. The term display drive luma is used to refer to values that include display drive compensation, such as for example physical gamma compensated signals. Thus, the display drive luma term refers to a non-linear luminance domain wherein a non-linear function has been applied such that a doubling in the display drive luma value does not correspond directly to a doubling of the luminance output of the corresponding display. In many current scenarios, signals are provided in a non-linear display drive luma format because this (coincidentally) also approximates the non-linear nature of human vision.

In the system of FIG. 1, the quantization adaptor 109 is specifically arranged to first determine a uniform quantization scheme in the perceptual luma domain. Such a uniform perceptual luma quantization scheme may e.g. be determined by generating a perceptual luma range which is linear in terms of JNDs. The perceptual luma quantization steps may then be generated by dividing the range into a number of equal intervals corresponding to a maximum number of bits available for each luminance value. For example, if 10 bit are available, the linear perceptual luma range is divided into 1024 equal intervals resulting in 1024 quantization steps that each correspond to the same perceived difference in luma/brightness.

The quantization adaptor 109 then proceeds to convert these uniform quantization steps into non-uniform quantization steps in the display luminance domain, i.e. into a non-linear quantization of the luminance sample values of the video signal.

This conversion is based on a mapping function which relates perceptual luma values to display values, and in the specific example directly to display luminance values. Thus, the mapping function directly defines the display luminance value (typically represented by the corresponding luminance sample value assuming a given correlation to display luminance) that corresponds to a given perceptual luma value. Such a mapping function may be determined based on experiments, and various research has been undertaken to identify the relationship between perceived luma steps and corresponding display luminance steps. It will be appreciated that any suitable mapping function may be used.

However, rather than merely use a fixed mapping function relating the perceptual and display domains, the quantization adaptor 109 of FIG. 1 is arranged to adapt the mapping function to take into account the veiling luminance estimate. Thus, the mapping function is further dependent on the veiling luminance estimate and is thus dynamically adapted to reflect this.

Again, it will be appreciated that the relation between image sample values and actual display outputs may be based on an assumption of a standard or nominal display. For example, the encoding may assume rendering by a standard HDR display with a luminance range from 0.05-2000 cd/m².

The quantization adaptor 109 then uses the veiling luminance estimate dependent mapping function to determine the non-uniform quantization steps for the display luminance from the uniform quantization steps in the perceptual luma domain. Specifically, the mapping function may be applied to each quantization interval transition value in the perceptual luma domain to provide the corresponding quantization interval transition value in the display luminance domain. This results in a non-uniform set of quantization intervals.

It will be appreciated that any perceptually relevant function can be used as a mapping function.

In more detail, a mapping function that converts luminance values to perceptually uniform luma values may be defined assuming no eye glare or veiling luminance:

l=f_{Y→pu}(Y)

where l is a perceptually uniform luma space, and Y is display luminance.

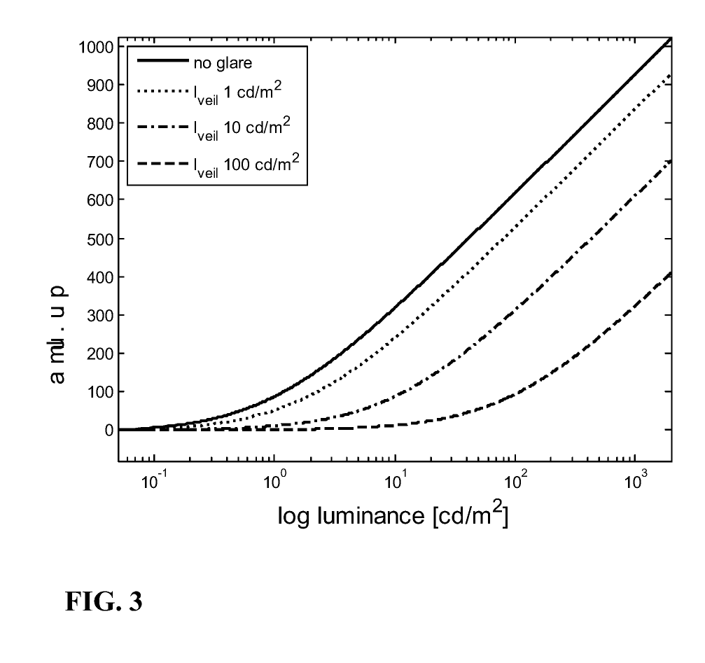

An example function is depicted as the solid curve in FIG. 3. It should be noted that the horizontal axis is log luminance and the curve clearly illustrates the approximate log response of human photoreceptors except for the lowest intensity levels. It will be appreciated that in different embodiments, different models of the human visual perception and thus different corresponding mapping functions may be used.

As the mapping function is a one-to-one mapping, the equivalent corresponding inverse function can be defined similarly:

l=f_{pu→Y}(Y)

The defined function is conservative/inaccurate as it does not consider the effect of eye glare. Accordingly, the quantization adaptor 109 uses the non-glare mapping function as the basis of the veiling luminance estimate dependent function.

Specifically, the quantization adaptor 109 modifies the basic function by the following adjustment:

l_{glare}=f_{Y→pu}(Y,Yᵥₑᵢₗ)=f_{Y→pu}(Y+Vᵥₑᵢₗ)−f_{Y→pu}(Yᵥₑᵢₗ)

where l_{glare} is a perceptually uniform luma value including the effect of glare, and Yᵥₑᵢₗ is the estimated veiling luminance level.

In effect, the quantization adaptor 109 adds the estimated global veiling luminance to the image luminance to model the scattering in the eye. This horizontal linear shift of the basic function of FIG. 3 provides a suitable estimate of the relation between display luminance and perceptual luma for a given veiling luminance. However, it also results in an offset (i.e. even for no display luminance (e.g. a black pixel in a bright image), the perceptual luma value is not zero. However, as the intention is to provide a suitable quantization scheme it is preferably to start with data values of zero for the data samples. Accordingly, the perceptual luma offset is removed by the subtraction of the luma mapping of the veiling luminance. As an effect, the perceptual luma scale represents the accumulation of JNDs.

The veiling luminance dependent mapping can be inverted as follows:

Y=f_{pu→Y}(l_{glare}+f_{Y→pu}(Yᵥₑᵢₗ))−Yᵥₑᵢₗ

Thus, this function can be used to provide a veiling luminance dependent mapping of the uniform perceptual luma quantization to the non-uniform display luminance quantization.

As can be seen from FIG. 3, which illustrates some example mappings from luminance to luma for different amounts of glare, fewer quantization levels are needed for increasing veiling luminances. Also, as illustrated the lower (darker) levels are quantized more coarsely, even to zero, as the veiling luminance increases.

Since the luma values are perceptually uniform they can be quantized uniformly:

l_{glareQ}=Q[l_{glare}]

where Q is a uniform quantizer, quantizing the signal to the available or required precision for encoding. For example, if 10 bits are used 1024 levels would be available. However, because the required number of levels is variable due to the glare, sometimes less bits are required. Hence, the quantification can be adapted to content. Furthermore, coarser quantization of certain areas can be exploited in entropy coding.

E.g. in the example of FIG. 3, the perceptual luma range is divided into 1024 quantization intervals/levels corresponding to 10 bits being available for encoding of each data sample. The display luminance range is 0.05 cd/m² to 2000 cd/m². As can be seen, when there is no eye glare (the basic function), all 1024 levels are needed to quantize the range from 0.05 cd/m² to 2000 cd/m². The basic curve thus provides a translation from each perceptual luma quantization level into the corresponding display luminance value. For example, level 100 corresponds to roughly 1 cd/m² and level 500 corresponds to roughly 25 cd/m².

However, for a veiling luminance of 1 cd/m², a flatter mapping function results and consequently the first few perceptual luma quantization steps correspond to much larger display luminance steps (reflecting that the dark areas cannot be differentiated due to the eye glare). For this veiling luminance estimate, level 100 corresponds to roughly 2 cd/m² and level 500 corresponds to roughly 80 cd/m². Furthermore, whereas 1024 levels were needed to cover the display luminance range from 0.05 cd/m² to 2000 cd/m² when no eye glare is present, the larger quantization steps when the veiling luminance increases result in only around 920 steps being needed to cover the full display luminance range.

The effect is even more pronounced for a higher veiling luminance. E.g. for a veiling luminance of 100 cd/m², the first few perceptual quantization levels cover a large range of the display luminance. Indeed, for this veiling luminance estimate, level 100 corresponds to roughly 150 cd/m² and level 500 corresponds to a display luminance of well above 2000 cd/m² and is accordingly not used. Indeed, in this scenario the entire display luminance range from 0.05 cd/m² to 2000 cd/m² requires only around 400 quantization levels. Thus, in this example, 9 bits are sufficient for each luminance sample of the image and thus a significant coding improvement can be achieved without any significant perceptual degradation. Furthermore, the coarser quantization is likely to result in a reduced variation in the sample values (e.g. many more pixels may be quantized to zero for a dark image) making the resulting quantized image suitable for a much more efficient encoding (e.g. using entropy encoding).

The mapping function (whether expressed as a perceptual luma as a function of the display luminance or vice versa) may be implemented as e.g. a mathematical algorithm or as a look-up table. For example, the basic mapping function for no glare may be stored in a look-up table and the offsets due to the veiling luminance may be used to shift the look-up input value and/or the look-up output value as indicated by the above equations.

As previously mentioned, the correlation between display values and actual luminance or display output may be based on a nominal or standard display. Although a specific display used in a given scenario may deviate from this nominal or standard display, the approach will typically provide a significantly improved performance even when the actual display has a different relationship than the nominal or standard display.

The system may use an adaptive quantization which for example may be adjusted for each image. The coding efficiency may be improved. The encoder can furthermore include an indication of the quantization scheme used in the output data stream. Specifically, it can include an indication of the veiling luminance estimate in the output stream. This allows a decoder to determine the quantization scheme used and thus to apply the corresponding de-quantization scheme.

In some embodiments, the quantization of one image area may be determined based on a veiling luminance estimate which is determined for and represents another image area. Typically, the veiling luminance estimate may in such scenarios be determined for a bright area, and the quantization may be applied in a dark area. Thus, typically the veiling luminance estimate is determined for an area which has higher luminance (and appears brighter) than the average luminance of the image. The resulting quantization may be applied to an image area that has lower luminance (and appears darker) than the average luminance of the image.

For example, an HDR display may be used to render an image in which the sun is shown e.g. in the upper right corner. An object may e.g. cast shadow in the lower left corner. The very bright image area corresponding to the sun will in such scenarios typically induce a veiling luminance in the user's eyes that prevents the user from perceiving any of the detail in the shadow sections. This may be reflected in the quantization which may be made coarser in the dark areas due to the presence of the sun. If the sun subsequently moves out of the image (e.g. due to a camera pan), the veiling luminance will be reduced thereby allowing the viewer to see detail in the shadow areas. This will be reflected by the system as the quantization may automatically be adapted to provide a finer quantization in the dark areas.

In some embodiments, the quantization scheme may further be dependent on an estimate of the luminance adaptation of the eye. This effect reflects that the photoreceptor neurons in the retina adapt their sensitivity depending on the average light intensity they receive. Because of this adaptation, humans are able to see in a luminance range of about 14 orders of magnitude. In a fixed adaptation state, however, these neurons have a limited dynamic range, i.e.: 3-5 orders of magnitude. Hence, in case of a ‘bright adaptation state’ the response of the neurons to significantly lower light levels is negligible. Thus, next to veiling glare, the limited dynamic range of the photoreceptors further limits the dynamic range of what humans can actually perceive. Furthermore, adaptation is not instant and has a relatively slow response with temporal masking as a result. For example, after a bright explosion humans are temporarily blinded because the neurons do not respond to the relatively lower light levels following the explosion. This temporal masking effect was negligible for LDR displays but may be quite significant for HDR displays. Thus, not only may certain areas in a HDR frame be masked or perceptually less relevant because of bright areas in other parts of the frame but it may also be masked or perceptually less relevant due to bright areas in preceding frames.

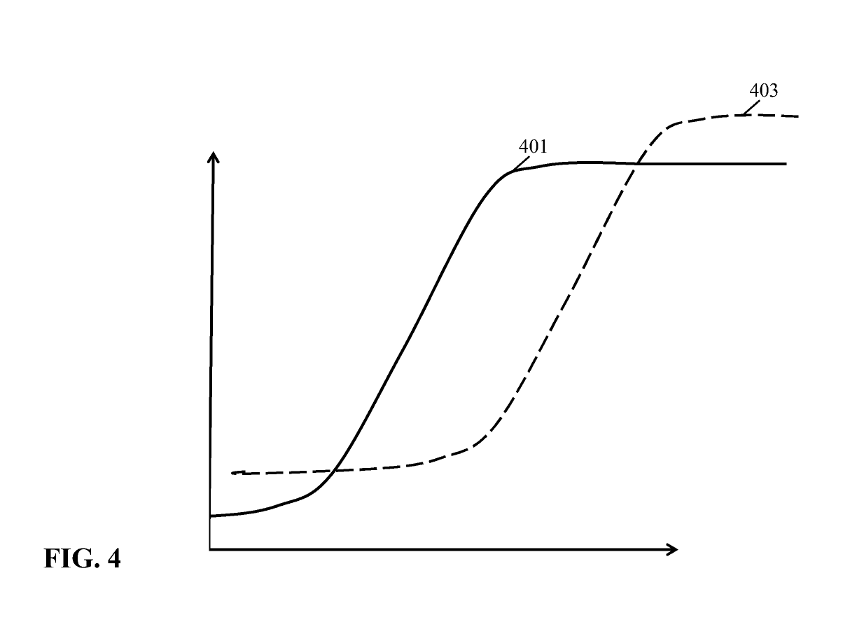

The effect is illustrated in FIG. 4 which illustrates curves 401, 403 indicating the sensed neuronal signal output (i.e. the output of the neurons) as a function of the input light in the cone. The correlation is shown for an example 401 wherein the eye is adapted to a relatively dark environment and for an example 403 wherein the eye is adapted to a relatively light environment. As can be seen, the eye is capable of generating a neuronal signal output which extends over a given dynamic range. However, the brightness that is covered by the dynamic range depends on the adaptation of the eye.

For example, a person may be standing outside on a bright sunlit day. His eyes will be adapted to the bright environment and he will be able to perceive many nuances in the environment. This may specifically correspond to the adaptation of the eye represented by curve 403 in FIG. 4. If the person then enters a dark cave, the light input from the environment will be reduced substantially. The person will in this case at first not be able to see details in the dark due to the neurons not being adapted to the low light. As indicated in FIG. 4, curve 403 indicates that the neuronal output signal is in this adaptation state almost constant for low light.

However, gradually the neurons will adapt to the darkness, and specifically the relationship may switch from that of curve 403 to that of curve 401. Thus, the person will gradually be able to see more and more detail in the dark as the relationship moves towards curve 403.

If the person then steps back out of the cave into the sunlight, the adaptation to the dark represented by curve 401 prevents the user from seeing the bright details. As the person's eyes then gradually adapt back to curve 403, he will increasingly be capable of seeing more and more bright detail.

It should be noted that this effect is a completely different physical effect than veiling luminance. Indeed, whereas veiling luminance represents scattering of light inside the eye and towards the retina, the adaptation effect reflects the chemical behavior of the retina.

Contrary to limitations caused by eye glare, the limitation of the instantaneous dynamic range can also reduce sensitivity for very bright image details and, most importantly, the luminance adaptation introduces temporal effects as it takes time for the eye to adapt. In the system of FIG. 1, the focus is on the temporal effects of adaptation as it can often be accurately assumed that the limitation of the dynamic range in the adapted state is mainly caused by eye glare when viewing natural images. In fact, in extreme conditions eye scatter can limit the visible dynamic range of a perceived image to about 1:30.

Furthermore, the masking due to an unadapted state will mainly consider the dark areas of the image. This is because light adaptation is much quicker (just a few seconds or less) than dark adaptation (in the order of 10 seconds to minutes) and because people are often adapted to the bright areas of the image. Therefore, the reduction of highlight detail visibility is negligible. Thus, the system focuses on dark detail loss due to the limited instantaneous dynamic range (in combination with the adaptation state), and the effect is taken into consideration by adapting the glare model for the quantization of dark areas. Specifically, the luminance adaptation is modeled by expanding the glare based quantization model described previously. This is specifically done by introducing a virtual glare, which models the unadapted states, into the glare model. This is in the system of FIG. 1 done by temporally low pass filtering the veiling luminance estimate.

In particular, a recursive temporal (IIR) filter may be applied to the generated veiling luminance estimate. For example, the following filter may be introduced:

Y_{virtual veil}(t)=β·Yᵥₑᵢₗ(t)+(1−β)·Y_{virtual veil}(t−1)

where Y_{virtual veil}(t) represents the generated veiling luminance estimate at time t and β is a filter parameter.

Thus, the low pass filtering ensures that the quantization is such that after a bright image (i.e. high veiling luminance estimate), the quantization only slowly adapts to a darker image thereby resulting in heavy quantization of the dark areas.

The low pass filtering may advantageously have a 3 dB cut-off frequency of no more than 2 Hz, or even advantageously 1 Hz, 0.5 Hz or 0.1 Hz in some embodiments. This will ensure that the adaptation of the model follows the slow luminance adaptation of the human eye.

In many embodiments, the low pass filter may advantageously be an asymmetric filter having a faster adaptation for increments in the veiling luminance estimate than for decrements in the veiling luminance estimate. Thus, the low pass filter may be asymmetric to reflect the difference in the time responses of dark and light adaptation. Moreover, since we ignore sensitivity loss in bright areas and since light adaptation is quick, it may in many embodiments be advantageous to only include a time constant for dark adaptation and assume light adaptation is instantaneous. For example, the design parameter a for the recursive filter may be given as:

$$β = \{ \begin{matrix}1 / {τ}_{dark} , & {Y}_{veil} ( t ) < {Y}_{virtual veil} ( t - 1 ) , \\ 1 , & {Y}_{veil} ( t ) \geq {Y}_{virtual veil} ( t - 1 )\end{matrix}$$

where τ_{dark}, the dark adaptation time constant, is in the order of e.g. 4 seconds. Thus, for a frame rate of 25 frames the time constant is around 100 frames corresponding to β=0.01 when the image darkens.

FIG. 4 illustrates an example of elements of a decoder in accordance with some embodiments of the invention. The decoder comprises a receiver 501 which receives the encoded video signal from the encoder of FIG. 1. Thus, the receiver 501 receives an encoded video signal with a number of encoded images which are quantised in accordance with a given quantization scheme that is dependent on the veiling luminance estimate. The received signal furthermore comprises an indication of the veiling luminance estimate generated by the encoder and used in the quantization. The indication may be a direct indication of the veiling luminance estimate (such as a value thereof) or may be an indirect indication (such as an indication of an appropriate encoding scheme).

In the example, the received signal directly comprises an indication of the veiling luminance estimate value. The veiling luminance estimate is accordingly fed to a decode quantization adaptor 503 which selects a suitable de-quantization scheme based on the veiling luminance estimate. Specifically, the decode quantization adaptor 503 may be arranged to apply exactly the same selection algorithm based on the veiling luminance estimate as was used by the quantization adaptor 109 of the encoder. Thus, the decode quantization adaptor 503 determines the corresponding/complementary de-quantization scheme to the quantization scheme used in the encoder.

The decoder also comprises a decoder unit 505 which receives the encoded images. The decoding unit 505 decodes the encoded images by performing the complementary operation to the encoding unit 105 of the encoder.

The decoder further comprises a de-quantiser 507 which is coupled to the decoder unit 505 and the decode quantization adaptor 503. The de-quantiser 507 applies the selected de-quantization scheme to the decoded image data to regenerate the (approximate) original video signal.

Thus the encoding and decoding system of the encoder of FIG. 1 and the decoder of FIG. 4 provides for an efficient distribution of the video signal using a veiling luminance dependent quantization. A closer adaptation of the encoding process to the human perceptual system may be achieved allowing an improved perceived quality to data rate ratio.

It will be appreciated that the quantization adaptor 503 may in some embodiments also provide control input to the decoder 505 (as indicated by the dashed line of FIG. 4). For example, the quantization adaptor 503 may indicate to the decoder whether a current image is encoded with a 10 bit or 9 bit luminance sample representation. It will also be appreciated that whereas the functional blocks of the decoder unit 505 and the de-quantiser 409 are illustrated as separate and sequential blocks, they may indeed be integrated and the combined functionality be distributed and performed in any suitable order.

The approach may in particular be applied to an HDR signal which is arranged to provide a significantly higher dynamic range and thus resulting in much stronger eye glare and luminance adaptation effects.

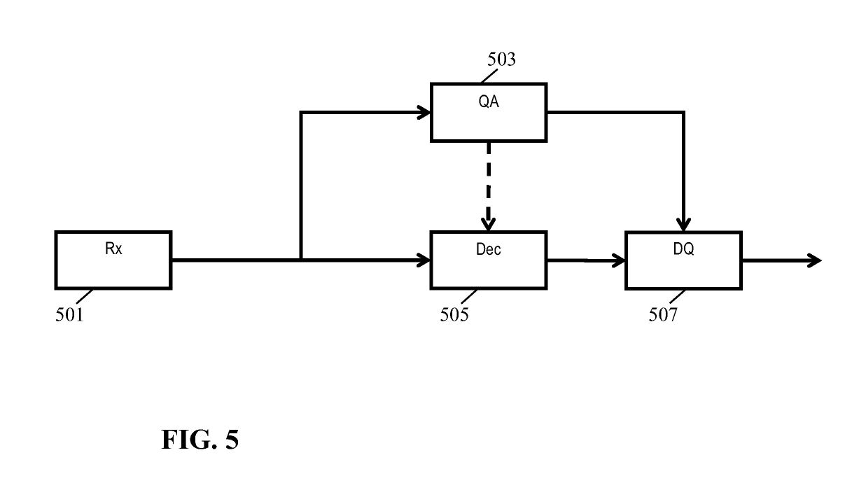

In some embodiments, the HDR image may be represented as a differential image relative to a corresponding LDR image. However, the described approach may still be applied. An example of such an encoder is provided in FIG. 5 which illustrates an example of elements of a video signal encoder in accordance with some embodiments of the invention.

The example corresponds to the encoder of FIG. 1 with the addition of an LDR encoding path and functionality for creating a differential HDR image. In the example, an LDR image corresponding to the HDR image (e.g. generated by colour grading/tone mapping) is fed to an LDR encoder 601 which generates an encoded LDR outputs stream comprising the encoded LDR images. The encoded LDR data is furthermore coupled to an LDR decoder 603 which performs the same decoding of the LDR data as will be performed in a remote decoder.

The resulting decoded LDR image is fed to an HDR predictor 605 which generates a predicted HDR image from the decoded LDR image. It will be appreciated that various HDR prediction algorithms will be known to the skilled person and that any suitable approach may be used. As a low complexity example, the input dynamic luminance range may simply be mapped to a larger luminance range using a predetermined look-up table. The HDR predictor 605 reproduces the HDR prediction that can be performed in a remote decoder and the predicted HDR image thus corresponds to the HDR image that a decoder can generate based only on LDR data. This image is used as reference image for the encoding of the HDR image.

In the system of FIG. 5, the quanitsed HDR image generated by the quantiser 103 is thus subtracted by the predicted HDR image in a subtractor 607. The resulting differential (error) image is then fed to the encoder 105 which encodes it to provide (difference) HDR output data.

It will be appreciated that in some embodiments the perceptual adaptive quantization may be performed on the difference image, i.e. it may be performed on the output of the subtractor 607 (in other words the positions of the perceptual quantiser 103 and the subtractor 607 of FIG. 5 may be interchanged). However, in such an embodiment the perceptual quantization may not depend only on the encoded difference HDR image but also (or additionally) on the predicted HDR image (or the original HDR image) since the perceptual quantization depends on absolute luminance values and not just relative or differential luminance values. Indeed, in some embodiments, the veiling luminance estimate and the corresponding quantization for the difference image may be determined exclusively based on the HDR prediction image. E.g., a veiling luminance estimate may be determined for each HDR prediction image. For each pixel of the HDR prediction image, the quantization step size that corresponds to the predicted HDR luminance may be determined. This quantization step size may then be applied to the error (difference value for that pixel). The use of the predicted HDR image for determining the quantisation rather than the original HDR image may facilitate operation as the predicted HDR image is also available in the decoder.

The example of FIG. 5 represents a scalable encoding of an HDR image with the residual data relative to an HDR image being generated by prediction from an LDR image. However, it will be appreciated that in other embodiments, the HDR image may be encoded as an absolute image rather than relative to an LDR or estimated HDR image. For example, the system of FIG. 5 may generate independent encodings of the HDR image and the LDR image by removal of the LDR decoder 603, the HDR predictor 605 and the subtractor 607.

The previous description has focussed on examples wherein the image samples directly included luminance samples. In the examples, the determined quantization scheme is applied directly to the luminance samples. The quantization of chroma samples may e.g. follow a uniform or any suitable quantization.

However, it will be appreciated that the approach is not limited to representations including direct luminance samples but may also be applied to other representations, such as e.g. RGB representations. For example, an RGB signal may be converted to a YUV representation followed by a quantization as described for the YUV signal. The resulting quantised YUV signal may then be converted back to an RGB signal. As another example, the quantization scheme may be a three dimensional sampling scheme where the veiling luminance estimate is directly converted into a three dimensional set of quantization cubes. Thus, in such an example a combined quantization of e.g. the RGB samples is performed (e.g. the quantization of an R sample may also depend on the G and B values thereby reflecting the corresponding luminance of the RGB sample).

The previous description has focussed on scenarios wherein the video signal comprises samples in accordance with a luminance colour representation, and specifically in accordance with a linear luminance colour representation. However, it will be appreciated that the described approach is applicable to many different representations. In particular, the approach may also be used for display compensated representations, such as specifically gamma compensated representations.

For example, the input video signal may be received from a video camera providing a signal in accordance with Rec. 709, i.e. providing a signal with gamma compensated samples. In such an example, the receiver 101 may convert the gamma compensated input samples to samples in the luminance domain. For example, it may convert a Y′CrCb input signal to a YCrCb which is then processed as previously described.

Similarly, in the example the output of the encoder is provided in a (linear) luminance domain rather than in a display drive luma space. However, in other embodiments the output of the encoder may be provided in accordance with a display drive luma scheme such as Y′CrCb. In such an example, the linear luminance samples generated by the encoder of FIG. 1 may be converted into a display drive luma samples, such as specifically gamma compensated samples, e.g. output YCrCb samples may be converted to Y′CrCb samples (or RGB samples may be converted to R′G′B′ samples).

Furthermore, in embodiments where the output samples are provided in a display drive luma representation, the quantisation in the luminance domain may be converted to the display drive luma domain and used directly to compensate a signal provided in this domain. Thus, the encoder of FIG. 1 may operate with samples that are display drive compensated (specifically samples in accordance with a gamma compensated scheme such as in accordance with Rec. 709). This may be achieved by converting the determined quantisation levels in the luminance domain to corresponding levels in the display drive luma domain. This may be done using a mapping function to the luminance domain followed by a (gamma) compensation or may be done by directly determining the mapping function to relate gamma compensated (or more generally display drive luma) values to perceptual luma values. E.g. the horizontal axis of FIG. 3 may be mapped to gamma compensated values. The mapping may be based on an assumed nominal or generic display (specifically an HDR display with assumed characteristics).

Thus, the mapping from linear luminance to display drive luma may be performed on the determined samples or on the quantisation scheme (specifically on the levels).

In the scenario wherein the samples remain in the display drive luma representation, the estimator 107 should take the drive (e.g. gamma) compensation into account t when determining the veiling luminance estimate (e.g. when determining the average luminance).

Similarly, the decoder may be arranged to operate with display drive luma values or with linear luminance values. For example, the decoder may operate as described for the example of FIG. 4 with the resulting output luminance values being gamma compensated to provide a suitable output for a display expecting a gamma compensated input (such as many CRTs, or newer displays operating in accordance with older display standards).

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An encoder for encoding a video signal, the encoder comprising:
a receiver for receiving a video signal comprising at least one image;
an estimator for determining a veiling luminance estimate for at least part of a first image of the at least one image in response to an image luminance measure for at least one of the at least one images, the veiling luminance estimate being an eye glare estimate;
a quantization adapter for determining a quantization scheme for the at least part of the first image in response to the veiling luminance estimate; and
an encoding unit for encoding the video signal using the quantization scheme for the at least part of the first image.

2. The encoder of claim 1 wherein the quantization scheme represents a uniform perceptual luma quantization scheme for the veiling luminance estimate.

3. The encoder of claim 1 wherein the quantization adapter is arranged to:
determine a uniform quantization scheme in a perceptual luma domain;
determine a mapping function relating perceptual luma values to display values in response to the veiling luminance estimate; and
determine the quantization scheme for display values in response to the uniform quantization scheme in the perceptual luma domain and the mapping function.

4. The encoder of claim 3 wherein quantization intervals of the non-uniform quantization scheme for display values comprises fewer quantization levels than the uniform quantization scheme in the perceptual luma domain.

5. The encoder of claim 3 wherein quantization interval transitions of the non-uniform quantization scheme for display values correspond to quantization interval transitions of the uniform quantization scheme in the perceptual luma domain in accordance with the mapping function.

6. The encoder of claim 1 wherein the estimator is arranged to generate the veiling luminance estimate in response to an average luminance for at least an image area of the first image.

7. The encoder of claim 6 wherein the estimator is arranged to determine the veiling luminance estimate substantially as a scaling of the average luminance.

8. The encoder of claim 1 wherein the estimator is arranged to determine the veiling luminance estimate as a weighted average of luminances in parts of successive images.

9. The encoder of claim 8 wherein the weighted average implements a temporal filter with a 3 dB cut-off frequency of no higher than 2 Hz.

10. The encoder of claim 8 wherein the weighted average is asymmetric with a faster adaptation for increments in the veiling luminance estimate than for decrements in the veiling luminance estimate.

11. The encoder of claim 1 wherein the encoder unit is arranged to include an indication of the veiling luminance estimate in an encoded output signal.

12. The encoder of claim 1 wherein the quantization scheme is determined for a first image area, and the veiling luminance estimate is determined for a second image area.

13. The encoder of claim 12 wherein the first image area is an image area having a lower than average luminance, and the second image area is an image area having a higher than average luminance.

14. A decoder for decoding an encoded video signal comprising at least one image, the decoder comprising:
a receiver for receiving the encoded video signal, the encoded video signal comprising a veiling luminance estimate for at least part of a first image of the at least one images, the veiling luminance estimate being an eye glare estimate;
a de-quantization adaptor for determining a de-quantization scheme for the at least part of a first image in response to the veiling luminance estimate; and
a decoding unit for decoding the encoded video signal using the de-quantization scheme for the at least part of the first image.

15. A method of encoding a video signal; the method comprising:
receiving a video signal comprising at least one image;
determining a veiling luminance estimate for at least part of a first image of the at least one image in response to an image luminance measure for at least one of the at least one images, the veiling luminance estimate being an eye glare estimate;
determining a quantization scheme for the at least part of the first image in response to the veiling luminance estimate; and
encoding the video signal using the quantization scheme for the at least part of the first image.

16. A method of decoding an encoded video signal comprising at least one image; the method comprising:
receiving the encoded video signal, the encoded video signal comprising veiling luminance estimate for at least part of a first image of the at least one images, the veiling luminance estimate being an eye glare estimate;
determining a de-quantization scheme for the at least part of the first image in response to the veiling luminance estimate; and
decoding the encoded video signal using the de-quantization scheme for the at least part of the first image.

17. A computer program comprising computer program code means adapted to perform all the steps of claim 15 when said program is run on a computer.

18. A computer program as claimed in claim 17 embodied on a computer readable medium.
